(19) United States
(12) Patent Application Publication
(10) Pub. No.: US 2002/0049792 A1
(43) Pub. Date: Apr. 25, 2002

(54) Conceptual content delivery system, method and computer program product

(76) Inventors: David Wilcox, Brookline, MA (US); Loredo Sola, North Pomfrett, VT (US)

Correspondence Address: VENABLE, BAETJER, HOWARD AND CIVILETTI, LLP, P.O. BOX 34385, WASHINGTON, DC, 20043-9998, US

(21) Appl. No.: 09/944,216

(22) Filed: Sep. 4, 2001

Related U.S. Application Data
(60) Provisional application No. 60/229,315, filed on Sep. 1, 2000.

(51) Int. Cl. G06F 17/00

(52) U.S. Cl. 707/522; 707/512

(57) ABSTRACT

A system and method for organizing and structuring conceptual business information is disclosed addressing clustering, connecting and accessing information at the desktop by knowledge professionals for work, business and research related decision-making. This content delivery system licenses, selects, aggregates and organizes the high quality concepts from leading authors and publishers. The system combines information frameworks, content, technology, editorial and technological experts in an integrated environment that can continuously adapt to meet user needs and intentions. The invention creates a multi-dimensional framework for conceptual information, navigable based on variables such as subject. The invention can include aggregating and delivering electronic information, including, an editorial system and process for identifying conceptual content, organizing it into stand-alone components, structuring value-added products or services to meet the personalized needs of knowledge workers at the desktop; a unique business model, with “ecosystem” strategies, partnerships and an informational chain to syndicate conceptual information across a broad range of Internet channels, reaching knowledge workers; marketing and migration models to convert non-paying users of free information across a broad range of products and services based on conceptual information; and a fully integrated database processing system designed to deliver concept-oriented results whether a search push or an intention push. Establishing value-added products and services for knowledge workers, building a vibrant ecosystem through a content delivery value chain and sharing value created with syndication partners, the invention expands opportunities for knowledge workers to progress personally, and professionally through access to conceptual information personalized to requested intentions.

### CROSS-REFERENCE TO RELATED APPLICATION

The present invention is related to U.S. Provisional Patent Application No. 60/229,315, entitled “Conceptual Content Delivery System, Method and Computer Program Product,” filed Sep. 1, 2000, to Wilcox, et al.

### FIELD OF THE INVENTION

The present invention relates generally to content delivery and systems for creating and delivering content, and more particularly to systems for content delivery over the Internet.

### BACKGROUND OF THE INVENTION

Recent exponential growth of the Internet has brought a vast array of information to computer desktops of users and, more particularly, to knowledge worker users such as, e.g., business professionals. Developments of easy availability of news and other low cost content, a plethora of Web sites, and ubiquitous use of search engines to comb the Internet, are illustrative of the rapidity with which information delivery has been transformed in recent years.

The developments and advances have also caused a severe epidemic of information overload. For busy user professionals, information is the raw material needed to solve, e.g., work, research and business problems. However, conventional search engine technology is optimized for quantity, not quality. As the Internet's world wide web (“web”) continues to expand, and the number of pages that are indexed by search engines grows, the frustration level for professionals is increasing. Unfortunately, a user of a search engine often must wade through an inordinate number of search results in order to find sought after information or content.

The explosive growth of the Internet brings an avalanche of information to the desktop of knowledge workers, but the web has been surprisingly ineffective in providing access to one of the richest knowledge storehouses—books and other literary works by leading authors. Conventionally, the authors have been hesitant to permit their literary works to be placed on the Internet, for fear of loss of compensation for the content of the works. Instead, to justify the level of compensation charged by publishers for a book, authors conventionally have been asked to write books often hundreds of pages in length. Lengthy treatises and texts have been authored even where a shorter book might have more succinctly and clearly conveyed a concept. For a example, a writer of a book conventionally may write a 50 page description of a concept, but can be required by a publisher to lengthen the description to 300 pages, in order to sell it as a book. Unfortunately, this is inefficient for both writer and reader. Specifically, the writer has to write more, and the reader has to read more. Books are reviewed, recommended, summarized, and sold in great numbers on the web, but access to their content, freed from bound versions has not materialized.

What is needed then is easy access to the right information at the right time. For example, business professionals are time-starved, so finding relevant content from an overwhelming array of books on a shelf of a library or bookstore can be inefficient, inconvenient, difficult, and expensive. Previous attempts to put the entire content of a book online did not address the problem. First, content providers objected to placing their content online fearing theft of their intellectual property without compensation. Even if this resistance could be overcome, and the full text of books were available electronically, state-of-the-art search technology is still woefully inadequate at locating relevant concept information.

In addition to excessive information and no quality control over the information, another major obstacle faces user professionals, getting information needed to solve problems. As overabundant as some information on the Web may seem, a critical component needed for sound business decision-making is missing. Conceptual information content is not available on the Web. Conceptual content is valuable because concepts provide a framework for structuring and analyzing solutions to professional problems. As more work tasks move to the computer desktop, conceptual content needs to be more easily accessible and applicable to real-time problem solving. Using conventional content delivery mechanisms such as books to gather the problem solving information is inefficient. First, since portions of books relevant to a given concept may be minimal, it may be cost prohibitive for the user to access relevant information. Second, books are often written by a single author, so it can be difficult, or impractical to consider the opinions of other authors related to the same given concept. Conventionally, content that is not available at the computer desktop is left out of the business decision-making process.

### SUMMARY OF THE INVENTION

The present invention is directed to systems, methods, and computer program products for organizing, accessing, and personalizing conceptual information. In an exemplary embodiment the method can process various types of conceptual information using a multi-channel, extensible, and flexible architecture. In an exemplary embodiment, the invention can include a content delivery system that combines new information frameworks, content, technology, editorial and technological experts in an integrated organization that can continuously adapt to meet user needs and intentions.

The present invention can include a content delivery system that can organize, access and personalize information. In an exemplary embodiment, the invention can advantageously cluster, connect and structure information. The content delivery system of the present invention, in an exemplary embodiment, can also provide conceptual information processing services including isolating concepts from text; organizing information; and delivering personalized information to a computer desktop of a user. The personalized information can be continually updated. In addition, or alternatively, the content delivery system of the present invention, in an exemplary embodiment, can include a framework adaptable to a wide variety of content types. Exemplary content types can include, e.g., information relating to, e.g., professional fields of work, business and research.

The present invention advantageously can feature customized delivery of content information online and on demand.

An exemplary embodiment of the invention can include a method of aggregating conceptual content, organizing, structuring and personalizing the conceptual content for access at a computer desktop of a user. The method can include organizing information by concept; providing a framework for organized thinking and action; aggregating only the best concepts, matching intentions and needs of a user, limiting the amount of content, and enabling more investment in that content; creating multiple search and browse paths impacting many different aspects of service, including logically searching, and connecting conceptual information to the intention of the user; dividing documents into concepts enabling extensive knowledge integration, and creating new concepts; retaining verbatim original language of an author; using extensive keywords, qualified links, and concept types assigned by analysts; reviewing summary content that matches intentions of the user, and selecting specific documents; or integrating content in a variety of forms to address the intentions of the user and delivering the content to the desktop of the user.

Another feature of an exemplary embodiment of the invention can include, e.g., building an information ecosystem. The information ecosystem can enable all partners to benefit from the information. In an exemplary embodiment, partnerships and an informational chain can include, e.g.,: taking non-perishable conceptual information, and linking it to business, personal or professional decisions; serving as a marketing vehicle for microtransactions, subscriptions and hard copy publication sales; creating sophisticated tracking of access to content in exchange for royalty payments; supporting any of multiple pricing and subscription models including sophisticated linking, preview, purchase, and trade-up options; creating multiple microtransaction products so that the microtransaction products can flow into existing commerce models of partners; or measuring access of every user. Advantageously, in one exemplary embodiment partners can be granted access to aggregate information, where the information can be used to guide new content creation. Partners can include, e.g., publishers, authors, or syndication partners.

Other features of an exemplary embodiment of the invention can include: linking concepts to user intentions and decisions by, e.g.,: multiple browse and search paths, including a service suggesting strategies at each step in the process; a fully integrated hierarchy and semantic net with databases, enabling advanced knowledge integration; a unique 360° view hierarchy that can include hundreds of concepts integrated in a content database, semantic net, and/or one or more concept summaries; an extensively integrated set of keywords can be included as part of a network of information object terms including content database, a hierarchy and one or more concept summaries; linking any content related material to any other content related material; providing summary information including a ConceptGuide™, a ConceptNet™, or a ConceptSuite™; creating multiple options to learn a new language for user searching, in one embodiment ConceptNet™ can include a language browser and can include, e.g., extensive key words, qualified links, concept types, and can be assigned by analysts; extensive conceptual linking, including, e.g., linking identified by a type, and an intention; linking, and creating concept summaries, courses, or book reviews to address specific user intentions; or a database processing system including an accuracy verifying concept-oriented path optionally including a search push, or an intention push, and can be operative not to require human intervention.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 illustratively depicts a block diagram illustrating data flow in an exemplary embodiment of the present invention including a high level view of an editorial system and a production content delivery system;

FIG. 2A illustratively depicts a database diagram of an exemplary embodiment of the invention including an exemplary method of creating a directional association between two terms using an exemplary editorial system software application according to the present invention;

FIG. 2B illustratively depicts a diagram of an exemplary hierarchical relationship between a title term and several table of contents (TOC) terms;

FIG. 2C illustratively depicts a diagram of an exemplary embodiment of a compilation relationship linking various title terms and a suite term;

FIG. 2D illustratively depicts a diagram of an exemplary embodiment of a sibling relationship between various extracts and a suite;

FIG. 3 illustratively depicts a flow diagram of an exemplary embodiment of a database optimization process illustrating creating optimized javascript files for each title or record in a database with parent-child relationship associated objects and including the associated objects into the database and into the directory of the web server of the present invention;

FIG. 4 illustratively depicts a flow diagram of an exemplary embodiment of a process illustrating optimized user/browser interaction including creating data objects using javascript variables that can be used by web designers to format content pages without programming support for client browsers according to the present invention;

FIG. 5 illustratively depicts a flow diagram of an exemplary embodiment of an editorial concept aggregation process including aggregating conceptual content, organizing, structuring and personalizing it for access at a desktop according to the present invention;

FIG. 6 illustratively depicts an exemplary embodiment of a graphical representation of a concept guide including two exemplary levels according to the present invention;

FIG. 7A illustratively depicts an exemplary embodiment of a graphical representation of a user interface depiction showing a selected first level of the concept guide of the present invention;

FIG. 7B illustratively depicts an exemplary embodiment of a graphical representation of user interface depiction showing a list of third level choices from a selected choice of a second level choice from a selected first level choice of the concept guide of the present invention;

FIG. 8 illustratively depicts an exemplary embodiment of a value creation system for the content delivery system according to the present invention; and

FIG. 9 illustratively depicts an exemplary embodiment of an information seduction system according to the present invention.

### DETAILED DESCRIPTION OF AN EXEMPLARY EMBODIMENT OF THE INVENTION

A preferred embodiment of the invention is discussed in detail below. While specific implementations are discussed, it should be understood that this is done for illustration purposes only. A person skilled in the relevant art can recognize that other components and configurations may be used without parting from the spirit and scope of the invention.

The following patents in Table I include disclosure helpful in enabling persons having skill in the relevant art to make and use the present invention, and the contents of the patents are incorporated herein by reference in their entireties.

TABLE I

| | |
|---|---|
| US Pat. No. 5,970,469 | This patent appears to disclose a method for |
| | providing shopping aids and incentives |
| | to consumers through a computer network, |
| | including interrelated operating groups that strive |
| | to influence consumer-purchasing behavior. |
| US Pat. No. 5,999,908 | This patent appears to disclose a two-way |
| | interactive media enabling relationships to be |
| | built with individual customers and groups of |
| | customers throughout a product or service's |
| | life cycle. |
| US Pat. No. 5,897,620 | This patent appears to disclose a method |
| | addressing customer interaction, using complex |
| | workflows and databases. |
| US Pat. No. 5,889,863 | This patent appears to disclose a method for |
| | remote virtual point-of-sale processing using a |
| | multichannel, extensible, flexible architecture, |
| | using coded protocols to query a server remotely, |
| | obtaining captured information, payment |
| | administration information, inventory control |
| | information, audit information and process |
| | satisfaction information. |
| US Pat. No. 5,870,552 | This patent appears to disclose a method for |
| | publishing hypermedia documents over wide area |
| | networks (WANs), including addressing needs of |
| | publishers seeking to create and publish hyper- |
| | media content in electronic form across WANs; |
| | and a client-server development system for handl- |
| | ing document authoring, content-based indexing |
| | and retrieval of documents, management and |
| | control of proprietary assets, and support for |
| | developing form-driven interactive services, all in |
| | a seamless WAN-integrated environment. |
| US Pat. No. 5,867,667 | This patent appears to disclose a publication |
| | network control system including domain server |
| | and client side communications resource locator |
| | lists for managing information communications |
| | between the domain server and publication |
| | servers. |
| US Pat. No. 5,867,667 | The patent appears to disclose a data processing |
| | system for integrated tracking and managing |
| | commerce related activities on a public access |
| | network, including managing transaction related |
| | information generated on a network of |
| | interconnected public access computers, and |
| | including monitoring purchases and providing |
| | referral fee accounting based thereon. |

Overview of the Present Invention

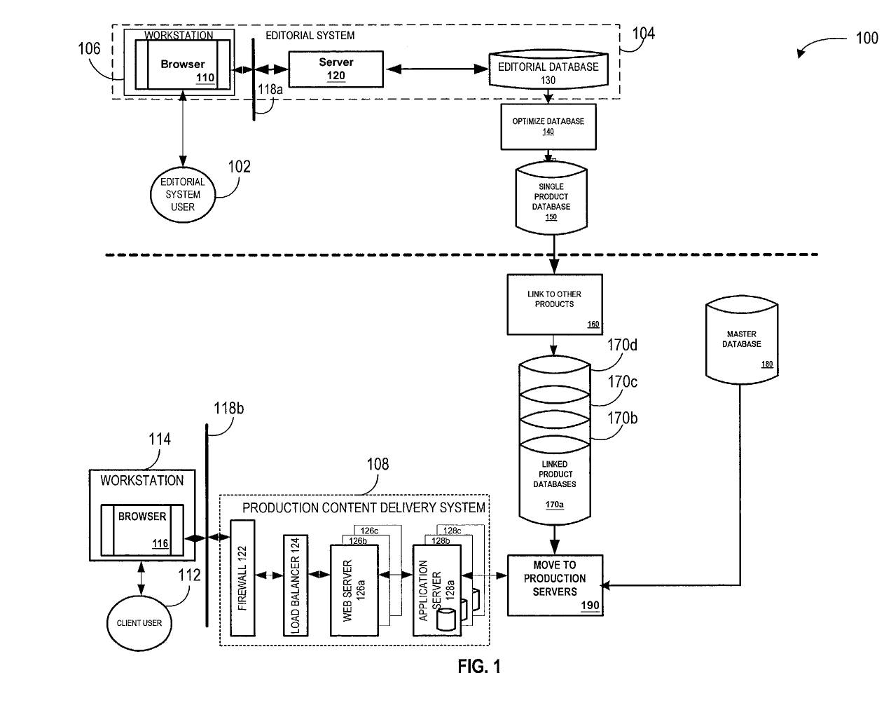

FIG. 1 illustratively depicts an exemplary embodiment of a block diagram 100 including data flows between an exemplary embodiment of an editorial system 104 and a production content delivery system 108. Block diagram 100 in the exemplary embodiment includes a high level view of various editorial and production system databases and illustrates various processing steps and data flows.

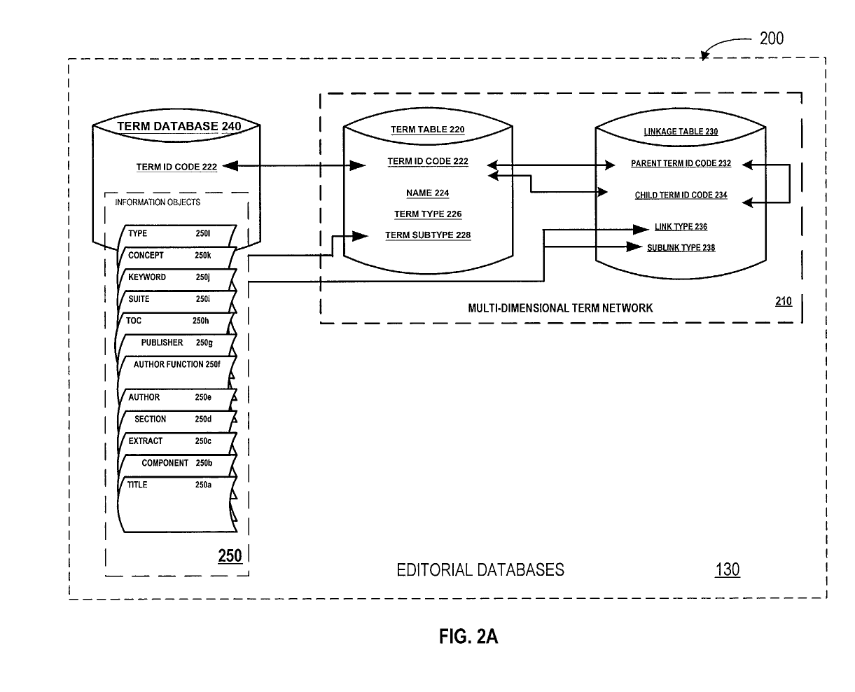

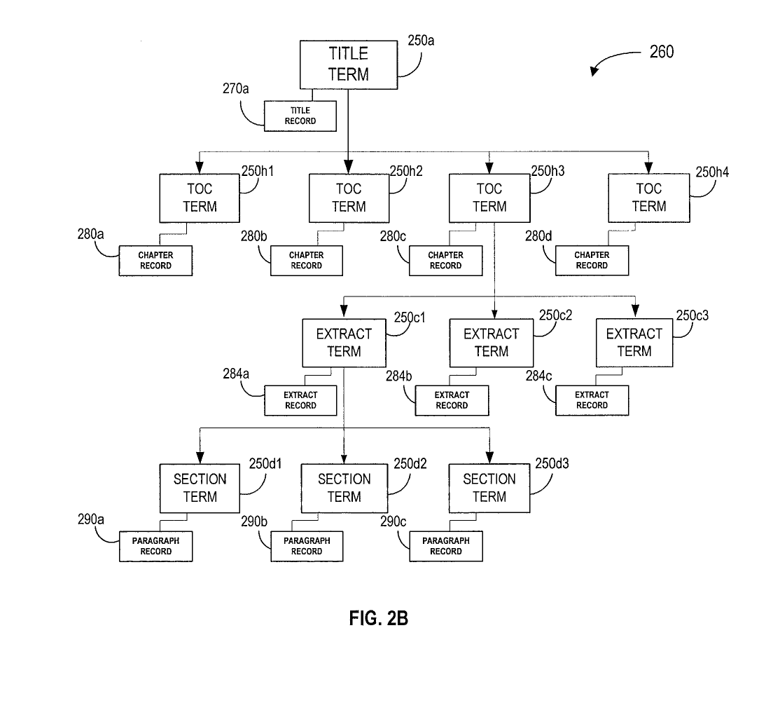

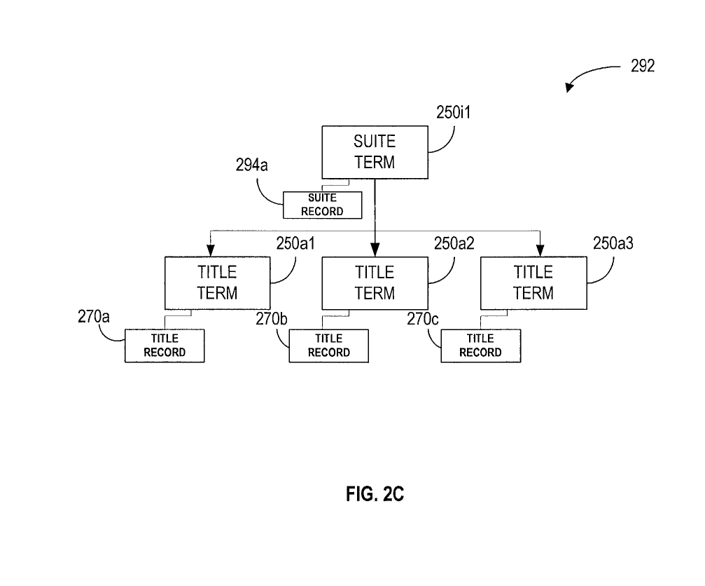

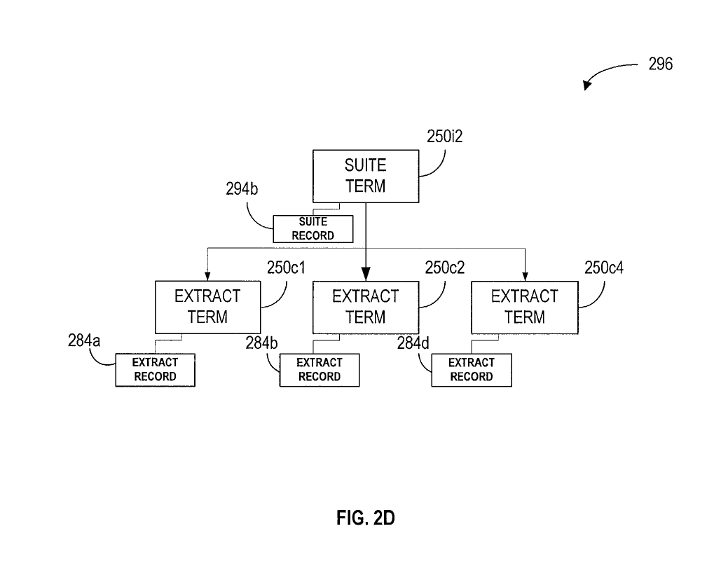

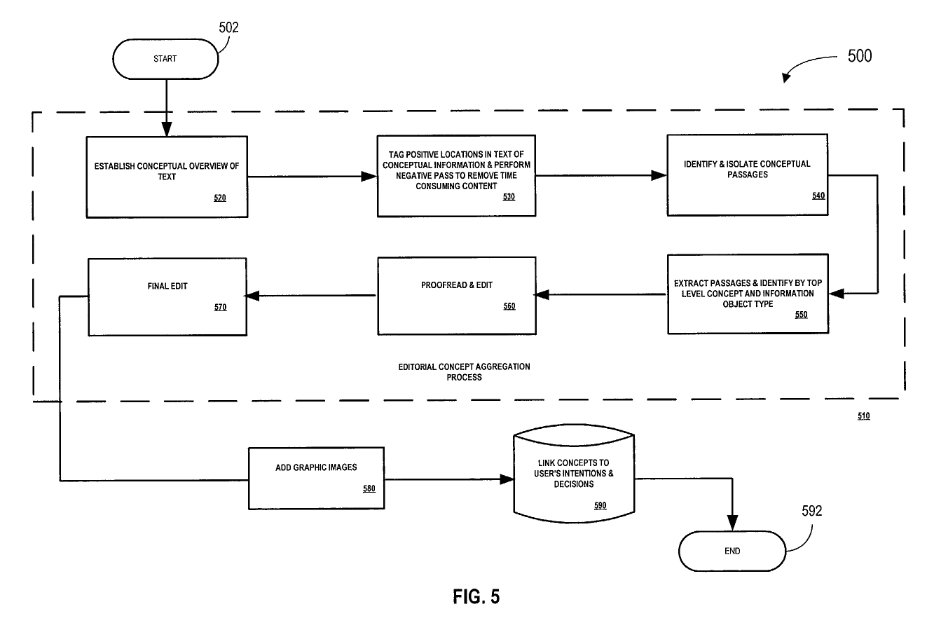

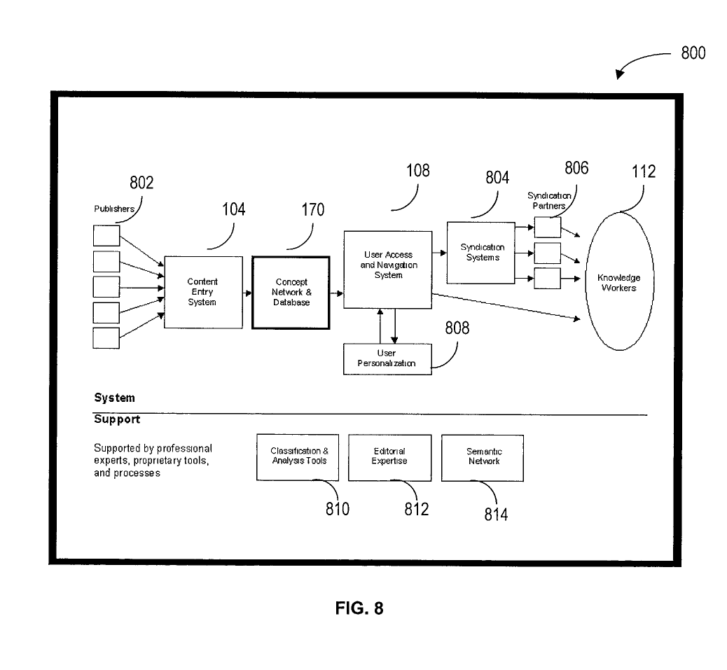

Block diagram 100 includes the editorial system 104 illustrating an editorial system user 102 interacting with a workstation 106 having a browser 110, coupled via a network 118a to a server 120 for backend access to an editorial database 130 according to an exemplary embodiment of the present invention. Various advantageous features of the editorial database 130 of the present invention are described further below with reference to a database diagram 200 of FIG. 2A, and with reference to FIGS. 2B-2D. The editorial system 104 can be used in performing an advantageous concept aggregation editorial process 510 including various beneficial features of an exemplary embodiment of the invention and is described further below with reference to FIG. 5. Examples of editorial system users 102 are described further below with reference to FIGS. 5 and 8. Editorial system users 102 can include various persons or entities such as, e.g., publishers 802, syndication partners 806, and editors.

Block diagram 100 also illustrates a client user 112 interacting with a workstation 114 having a browser 116, coupled via a network 118b to the production content delivery system 108 for access to production databases. Production content delivery system 108, in an exemplary embodiment, can include, e.g., a firewall 122, a load balancer 124, one or more web servers 126a-c, and one or more application servers 128a-c, providing access to production databases shown, but not labeled.

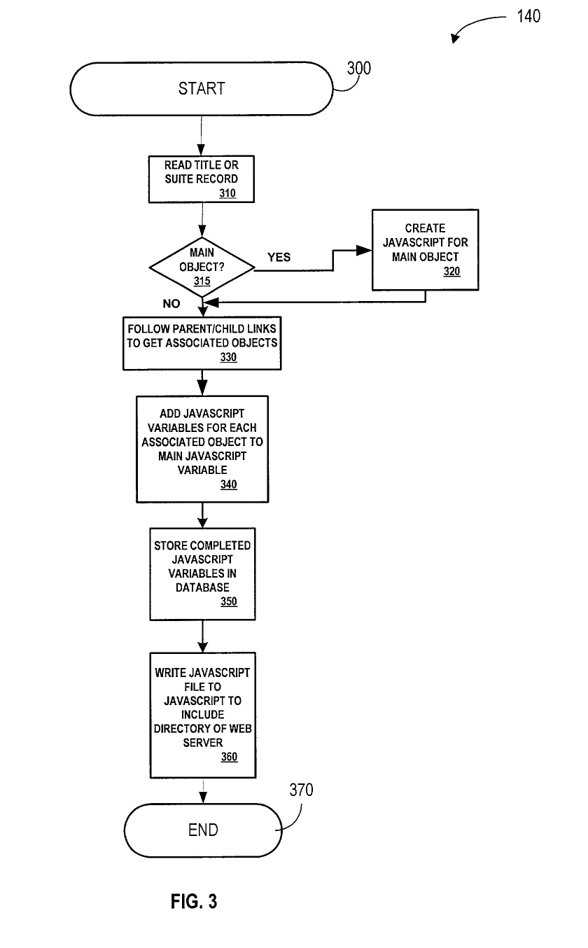

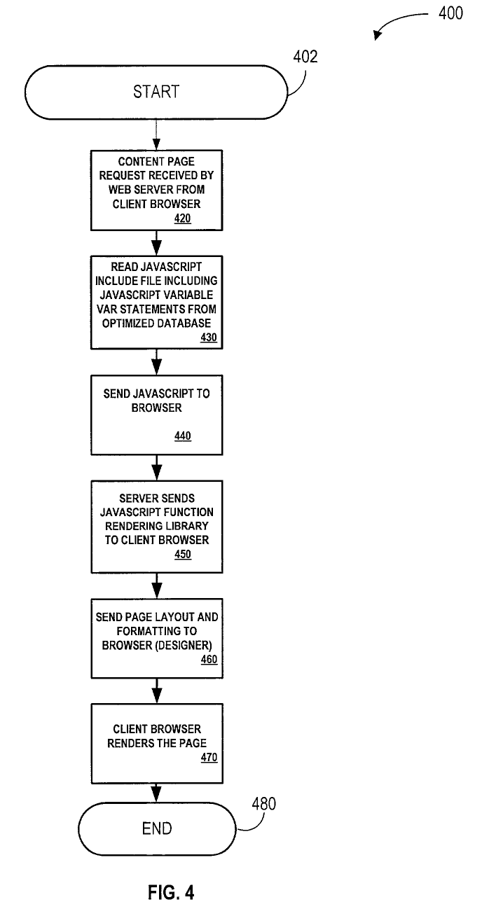

Block diagram 100 illustratively depicts an optimization process 140, accepting as input data from the editorial database 130 and outputting user-access optimized data to a single product database 150. The optimization process optimizes the data for client user 112 access rather than for editing. An exemplary embodiment of the optimization process 140 is described further below with reference to FIG. 3. Once the data of the single product database 150 is optimized for client user 112 access by the optimization process 140, the client user 112 can interact using browser 116 with the user access optimized data as described further below with reference to FIG. 4.

Block diagram 100 further illustrates in an exemplary embodiment, a linkage process 160, accepting as input user access optimized data from the single product database 150, processing links to other products, and outputting linked data to one or more linked product databases 170a-d, as shown. In an exemplary embodiment, after editorial content updates are completed, data from the master database 180, and linked product data from linked product databases 170a-d can be accessed and moved (or copied) in processing step 190 to one or more databases or storage devices of the production servers including, e.g., web servers 126a-c and application servers 128a-c, of the production content delivery system 108.

FIG. 2A illustratively depicts a database diagram 200 of an exemplary embodiment of the invention. Database diagram 200 can include editorial databases 130, which can be part of the editorial system 104, which can be an internal system used by internal or editorial system users 102 of the content delivery system. The advantageous structure, operation, or relationships of the components of the database 130 illustrated are not apparent to client users 112 of content delivered by the content delivery system of the present invention. Diagram 200 illustrates an exemplary embodiment of a method and system including a database of information objects 250 defining directional associations or linkages defined in linkage table 230 between two or more terms defined in term table 220.

Each record of content data extracted using the editorial aggregation process 510 described further below with reference to FIG. 5, and stored in editorial database 130, can have one or more terms associated with the record of content data, identifying the type of information contained in the record of content data (“content data record”).

According to the present invention, various types of information objects 250 can be defined to identify the type of the data within the content data record. Term database 240 can include all the types of information objects 250. Information objects 250 are referred throughout, interchangeably, as terms. A term includes a name, and an identifier (ID code). Information objects 250 or terms can include, e.g., all types of data objects such as, e.g., keywords, entries in a table of context, or an index, authors, publishers, titles of articles, magazine or journal titles, article titles, and newsfeeds. Terms or information objects 250 can be thought of as a hook or anchor allowing links to be placed between content. Specifically, in an exemplary embodiment, information objects 250 can include, e.g., any of the following objects, as shown, a title 250a, component 250b, extract 250c, section 250d, author 250e, author function 250f, publisher 250g, table of contents entry 250h, suite 250i, keyword 250j, concept 250k, and type 250l. For example, author function 250f can represent the role that an author plays such as e.g., a first author, an endorser, and an editor. Author 250e could represent the name of the author. Components 250b can be used in representing an anthology or a magazine, where the component term 250b can represent, e.g., a portion of the anthology or an article in the magazine.

Each information object 250a-l can have a connection into, or an entry in, a term table 220 and a linkage table 230. The term table 220 includes a list of all terms. This list can be advantageously added to later. For a given information object 250 identified by a term ID code 222 in term database 240, the term table 220 can include a record of information (i.e., a name and ID) defining the term. The linkage table 230 can define a relationship between the term identified by term ID code 222 and any other term within database 240 defined in term table 220. For example, a TOC information object 250h, can be considered a child of a title information object 250a. FIG. 2B described further below illustrates a relationship between multiple exemplary TOC information objects 250h and the title information object 250a.

A multi-dimensional network 210 can be used to define a term and to define a relationship between a first term and another term.

A term can be represented as a term record in term table 220. Each term in term table 220, can include any of various exemplary fields including, e.g., a term ID code 222, a name 224, a term type 224, and a term subtype 228.

The relationship between two terms can be defined by a link included in linkage table 230. The link can represent a relationship such as, e.g., a “parent-child,” or a “sibling,” relationship, linking any term to any other term. For a given term defined in term table 220, identified by term ID code 222, a relationship to another term can be defined using any of various fields of linkage table 230 including, e.g., a parent term ID code 232, a child term ID code 234, a link type 236, and a sublink type 238.

Hence, the multi-dimensional term network 210 can link, or associate, any content material to any other content material by defining terms and a relationship between the different terms. Hence, every term defined in term table 220, can have a relationship to another term , where the relationship is defined by a link stored in the linkage table 230.

In an exemplary embodiment, to avoid having to define a synonym database, commercial text retrieval products can be used. Alternatively, in another embodiment, a synonym database could be used.

FIG. 2B illustratively depicts a hierarchical diagram 260 of an exemplary relationship between a title term 250a and a plurality of table of contents (TOC) terms 250h1, 250h2, 250h3, and 250h4. Each TOC term 250h1-h4 can be thought of as corresponding to a chapter 280a-d of a book with a title 270a.

Similarly, extract terms 250c1, 250c2, and 250c3 can be linked to the TOC term 250h3, representing a linkage between extracts 284a, 284b, and 284c and chapter 280c, where extracts 284a-d could be components of chapter 280c.

Also similarly, section terms 250d1, 250d2, and 250d3 can be linked to the extract term 250c1, representing, paragraphs 290a, 290b, and 290c of the extract 284a, of chapter 280c, of a book having title 270a.

Other kinds of relationships can similarly be represented by the links in linkage table 230, as shown, e.g., in the exemplary embodiments of FIG. 2C and 2D.

FIG. 2C illustratively depicts a diagram 292 of an exemplary embodiment of the invention illustrating several titles related to a concept or subject. The concept can be represented by a suite term 250i1. Specifically, a relationship between various titles 270a, 270b and 270c included in a suite 294a, can be represented by suite term 250i1. For example, suite term 250i1 could represent a compilation such as, e.g., a magazine represented by suite record 294a. The compilation could include various articles named with titles 270a-270c, with the relationship corresponding to the compilation suite 294a of the articles of titles 270a-c represented by the link between title terms 250a1-a3 and suite term 250i1.

FIG. 2D similarly illustratively depicts a diagram 296 of an exemplary embodiment of the invention illustrating several extracts related to a single concept. The concept can be represented by a suite term 250i2. Specifically, a relationship between various extracts 284a, 284b, and 284d, represented by extract terms 250c1, c2 and c4, respectively, and a suite 294b, represented by suite term 250i2. For example, suite term 250i2 could represent a suite record 294b corresponding to a concept such as, e.g., “use of time management in meeting a goal.” Various extracts 284a, 284b, and 284d from different books could relate to the concept of the suite record 294b. The sibling relationship between the conceptually related extracts 284a, b, and d as represented in diagram 296 could then be defined by a link between extract terms 250c1, c2 and c4, and suite term 250i2.

Content Delivery System Architecture

The content delivery system illustrated in FIG. 1 of the present invention can deliver computer desktop access to client users 112 of the first database of verbatim content concepts. An underlying armature including two elements supports this concept delivery system. The first feature is the Concept Net^{SM}, the proprietary database system including the databases of FIG. 2A for managing the content associated with knowledge domains. The database can include thousands or more verbatim extracts from hundreds of books on a given topic. Service offerings can include such topics as, e.g., Business Management, Career Development, Professional Skills, Investment Planning, Financial Planning, and Information Technology.

The Concept Net feature can be used by a client user 112 to, e.g.,: find new ideas; prepare for meetings; frame problems; structure self-directed learning; consult book or journal article summaries; troubleshoot business processes; keep up-to-date on the latest trends; gain access to leading business thinkers; and find and buy the right books.

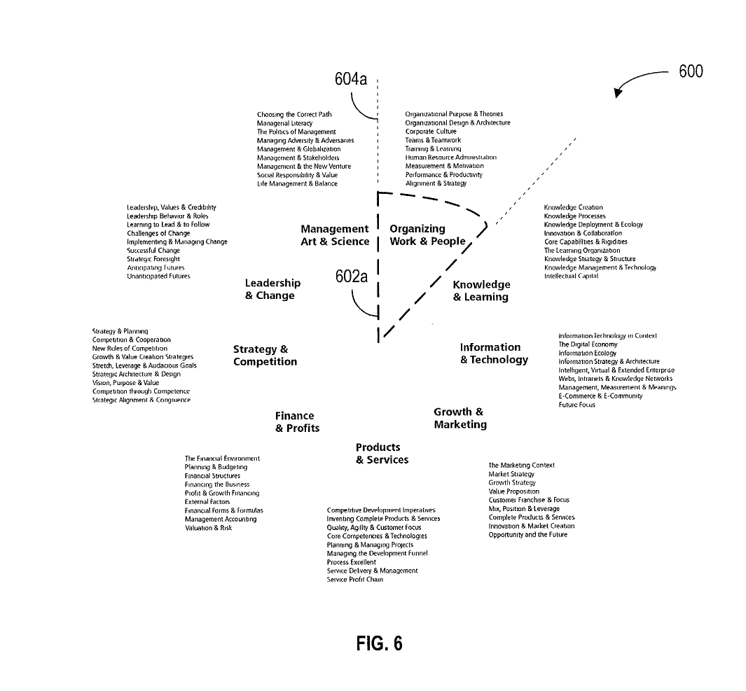

The second feature is the Concept Guide^{SM}, a simple, hierarchical, browseable classification system that can link the extracts generated by the advantageous extraction process of FIG. 5 in the Concept Net. The Concept Guide, graphically illustrated in FIG. 6 includes a novel comprehensive taxonomy for concepts of a topic area and can be accessible from the computer desktop of client user 112.

The concept guide 600 in an exemplary embodiment is a three-tiered model comprised of nearly 1000 categories nested under nine primary (level one) topics. FIG. 6 illustrates the exemplary categories included in levels 1 and 2 for an exemplary Business Management topic Concept Guide. Each topic in the exemplary concept guide 600 can house an associated interconnected group of extracts or passages that can be quoted verbatim from books. The verbatim quotes can be licensed from the copyright owner content provider. All extracts can be coded and associated with key words by editorial system users 102 of the content delivery system of the present invention using, for example, the process of FIG. 5, resulting in a powerful semantic network. The ideas found in the extracts can be accessed by drilling down through the concept guide 600 using, e.g., the graphical user interfaces depicted in FIG. 6, 7A and 7B, or by using the search tools provided. These tools integrate the latest state-of-the-art search technology, the concept guide 600 and the semantic network to provide a level of relevance unprecedented on the web today.

The advantageously simple hierarchical mechanism of the database structure of FIG. 2A allows the system's hierarchy to be innovated ongoing. Therefore, e.g., new types of content and new types of structuring of existing content can all be accommodated. The hierarchical mechanism can evolve, and grow, and change as the business changes, as new content is produced, and as new types and forms of content organization become necessary through editorial processes. The structure continually evolves, and becomes more complex and more connected in many complex ways as more and more links are created between terms.

Concepts can also be linked together. Cross conceptual linkages can allow a piece of content to define a link between two related concepts. All these types of relationships, including, e.g., parent to child, brother to brother, and sister to sister (sibling) relationships can be defined within the database structure of the present invention. Advantageously, one is not required to anticipate all possible future content relationships prior to gathering and aggregating content. Advantageously, the multi-dimensional term network 210 subsumes all linkage permutations within the same table 210, so one never has to create new tables to represent new forms of linkages. Network 210 includes a generalized linkage algebra that allows one to express any type of linkage between any two objects by simply adding records to the linkage table 230.

To illustrate the advantage of the present invention an alternative embodiment can. In the alternative embodiment, a separate table can be used for each type of linkage. In the separate linkage table embodiment, if, e.g., 5 objects are linked together in 25 different ways, if a sixth object is introduced, a new set of 25 linkage tables would be necessary just to support the one new, sixth object. Then, to add another or a seventh object, an additional 50 tables would be needed. To add another or an eighth object, 100 additional tables would be needed.

FIG. 3 illustratively depicts a flow diagram 140 of an exemplary embodiment of database optimization process 140. In an exemplary embodiment, on a periodic basis such as, e.g., once a day, or once per week, or on an aperiodic basis, the editorial database 130 which is optimized for editing and changing can be in an exemplary embodiment frozen, and optimized, creating an optimized database. The resulting optimized database can be optimized for serving the web and client users 112. Optimization process 140 can begin with step 300 which can continue immediately with step 310. The process can form the optimized database behind a content website.

In step 310, a title or suite record can be read into a processor from the editorial database 130. From step 310, optimization process 140 can continue with step 315.

In step 315 it can be determined whether the record is a main object. If the record is a main object, optimization process 140 can continue with step 320. Alternatively, if the record is determined not to be a main object, then optimization process 140 can continue with step 330.

In step 320, a main javascript variable (VAR) programming code file can be created for the main object. Content can advantageously be placed in the javascript VAR file for later transport and access by client users 112. From step 320, optimization process 140 can continue with step 330.

In step 330, the parent/child links identified by parent/child ID codes 232, 234 can be followed (including, e.g., parsing and requesting to get (i.e., access) the associated data records. From step 330, optimization process 140 can continue with step 340.

In step 340, javascript variable programming code can be added to the main javascript variable for each associated object. From step 340, optimization process 140 can continue with step 350.

In step 350, the completed javascript variable programming code can be stored in a database such as, e.g., single product database 150. From step 350, optimization process 140 can continue with step 360.

In step 360, a javascript file can be written to javascript to include the directory of a web server such as, e.g., web server 126a-c or application server 128a-c. From step 360, optimization process 140 can immediately end with step 370.

Each javascript file can include VAR statements. Optimization process 140 is an exemplary embodiment is one directional. The optimization process 140 collects all information about each informational object 250. The process pre-associates content for efficient high performance (i.e. fast response time) viewing and access via the web. Optimization process 140 illustrates creating optimized javascript files in steps 320, 340, 350, 360 for each title or record read in step 310 from database 130 using parent-child relationships of table 210 in step 330 and including associated objects in step 340 into the database in step 350 and writing the file into the directory of the web server in step 360.

Every syndication partner can need the content to be formatted for the partner's desired look and feel. So optimization the process 140 can aggregate the raw data content and store the data in VAR statements without adding the specific look and feel of the partner. Advantageously the javascript file includes using javascript include statements. The content in VAR statements is cached on the client user 112 workstation 114. Then javascript formatting and display functions can format the content.

FIG. 4 illustratively depicts a flow diagram 400 of an exemplary embodiment of a process illustrating client user/browser Interaction.

Client user/browser interaction process 400 begins with step 402 which can continue immediately with step 420.

In step 420, a client user 112 browser 116 can send a content page request to a web server 126a which can receive the request for content. From step 420, client user/browser interaction process 400 can continue with step 430.

In step 430, the web server 126a can read the javascript include file including var statements including data content from the optimized database of single product database 150. From step 430, client user/browser interaction process 400 can continue with step 440.

In step 440, the javascript can be sent to the browser 116 by, e.g., web server 126a. The browser 116 can cache the javascript VAR statements including the content. From step 440, client user/browser interaction process 400 can continue with step 450.

In step 450, the javascript function script rendering library can be sent to browser 116 by, e.g., web server 126a. From step 450, client user/browser interaction process 400 can continue with step 460.

In step 460, the page layout can be sent to the browser 116 and the formatting information can be sent to the browser 116. From step 460, client user/browser interaction process 400 can continue with step 470.

In step 470, the browser 116 renders the display of a page for viewing and interaction by client user 112. From step 470, client user/browser interaction process 400 can continue with step 480.

In step 480, client user/browser interaction process 400 can immediately end.

FIG. 5 illustratively depicts a flow diagram 500 of an exemplary embodiment of an editorial concept aggregation process 510 illustrating the process of extracting concepts from works of authorship such as e.g., books, magazines, anthologies, etc. The editorial concept aggregation process 510 can include, e.g., aggregating conceptual content, organizing, structuring and personalizing it for access at the computer desktop.

Flow diagram 500 can begin with step 502 and can continue immediately with step 520 of the editorial concept aggregation process 510.

In step 520, an editorial expert can pre-read the selected text by, e.g., scanning the table of contents, the introduction, table headings, the index, and the text to establish a conceptual overview reader guide of the entire text. The editor can create a one page description. The description, referred to as the reader guide can be printed and placed in the book to guide the extraction process. The description can identify the focus points and the method of concentrating based on the style of text. From step 520, flow diagram 500 can continue with step 530.

In step 530, in an exemplary embodiment, an editorial expert or trainee, e.g., can tag using, e.g., a Post-It Note®, highlighter, pen, or other identification means, positive locations in the text corresponding to conceptual information at the full or illustration level only. Removing untagged information removes unneeded, time consuming content. The removal of unneeded text of step 530 can be referred to as a “Negative Pass.” The tags can enable a subsequent “Read Pass” to skip over non-conceptual, non-relevant portions of the text. From step 530, flow diagram 400 can continue with step 540.

In step 540, in an exemplary embodiment, the editorial expert can identify and isolate conceptual passages using, e.g., marking or highlighting of “block quotations” which can form extracts. The editorial expert can also, e.g., supply distinctive names for each extract. From step 540, flow diagram 400 can continue with step 550.

In step 550, the marked passages can be extracted. This extracted data can then be, e.g., identified and written, scanned, or entered into a database. The editorial expert can add tags on electronic text by identifying each extract by, e.g., a top-level concept and by term type using an information object 250. Identifying each extract can include assigning a distinctive name to the extract. Identifying each abstract can also enable subsequent refined concept searching and personalization in an exemplary embodiment. From step 550, flow diagram 500 can continue with step 560.

In step 560, a “quality control pass” can be performed. The quality control pass can include various proofing tasks including, e.g., proofreading and editing, can be performed. From step 560, diagram 500 can continue with step 570.

In step 570, a final edit can be performed. The final edit can include other proofing including, e.g., marking “drop quote” topic sentences, reading for logic, and reading for flow. The result of the editorial concept aggregation process 510 can be a concept which can include, e.g., various textual excerpts or extracts. From step 570, flow diagram 500 can continue with step 580.

In step 580, graphic images can be, e.g., scanned and added to the textual extract. From step 580, flow diagram 500 can continue with step 590.

In step 590, the concepts extracted by the editorial concept aggregation process 510 can be stored in editorial database 130, and the database can link using linkage table 230 the stored data extract concepts to information objects representing categories of the intentions and selections of the client user 112. The results can be optimized for client user 112 access using FIG. 3. The results of the linking and optimization of data for client user 112 access can be delivered to the computer desktop of the client user 112 using the interactive browsing methods of FIG. 4. As will be apparent to those skilled in the relevant art, any references in the application to a computer, the workstation 106, 114, browser 110, 116, computer desktop, server, or other hardware or software device, are equally applicable to other devices, operating systems, and software including, e.g., any other application on any other device such as, e.g., a television device, a computing device, a telephony device, a communications device, a handheld, laptop, notebook, palmtop, wired or wireless device.

FIG. 6 illustratively depicts an exemplary embodiment of a graphical representation of a concept guide 600 including two exemplary levels in an exemplary pie-shaped metaphor graphical user interface (GUI). Other GUI depictions could be used to show categories of concepts or suites. In an exemplary embodiment, a first level could only be displayed on a computer display. Upon user 112 selection of a first slice 602a of the first level, another pie could appear including topics 604a of the second level associated with the selected first slice 602a. In an exemplary embodiment, upon user 112 selection of a topic of the second level slice 604a, another pie could appear including topics of a third level associated with the selected topic of the second slice 604a. As will be apparent to those skilled in the art, additional levels of concepts or suites can be nested within each ensuing level. As will be apparent to those skilled in the art, the content concepts can be organized in various alternative manners within the scope of the present invention.

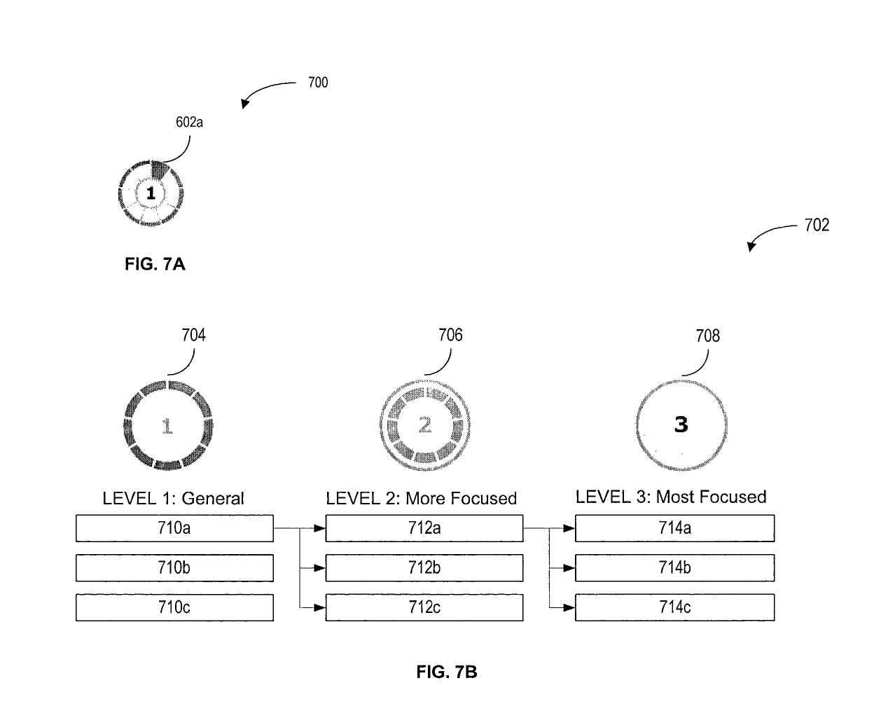

FIG. 7A illustratively depicts an exemplary embodiment of a graphical user interface depiction 700 of a selected first level slice 602a of the concept guide of the present invention. The logo can be used as a guide to the level of abstraction displayed in a web page including the depiction.

FIG. 7B illustratively depicts an exemplary embodiment of a graphical user interface depiction 702 showing an example of a graphical indicator of third level choices 714a, 714b and 714c from a selected second choice 712a of second level choices 712a, 712b, and 712c, selected from a selected first level choice 710a, of first level choices 710a, 710b, and 710c of the concept guide 600 of the present invention. GUI depiction 702 includes an exemplary embodiment of graphical representations of levels one 704, two 706, and three 708. Advantageously, a user can branch to other related concept areas or suites, compilations, or categories.

FIG. 8 illustratively depicts an exemplary embodiment of a value creation system 800 for the content delivery system of the present invention. Publishers 802 are illustrated providing content to, in exchange for value from, content entry system 104. Content entry system 104 is shown in an exemplary embodiment providing content to, in exchange for value from, concept network and database system 170. Concept network and database system 170 is shown in an exemplary embodiment providing content to, in exchange for value from, user access and navigation system 108. User access and navigation system 108 can interact with a user personalization system 808.

User access and navigation system 108 can provide content to, in exchange for value from, syndication partners 806. Syndication partners 806 can provide content to, in exchange for value from, knowledge worker users 112.

Alternatively, user access and navigation system 108 can provide content directly to, in exchange for value directly from, knowledge worker users 112.

Thus, content can be delivered all the way through the creation, and delivery process of diagram 800, in exchange for compensation which can be transacted back through the entire depicted value system 800.

The system, in an exemplary embodiment, can also be supported by professional experts, proprietary tools and processes including, e.g., classification and analysis tools 810, editorial expertise 812, and semantic network 814.

Content Acquisition

The content delivery system of the present invention can build strategic alliances with publishers 802. These alliances can provide the content delivery system with rights to extract verbatim content from the publisher's books and make it available on the Concept Net. Publishers 802 can collectively share a royalty pool equal to, e.g., 15 percent of net revenues of the content delivery system of the present invention. For the publishers 802a, benefit is the incremental book sales generated by exposure of their content to a larger audience than the publishers 802 currently reach. Online booksellers including, e.g., Amazon and Barnes & Noble can be used to facilitate the sales of books.

For example, Book publishers 802 can enter into license agreements with the content delivery system of the present invention. Publishers 802 can include international publishers as well as publishers 802 of leading journals.

The agreements signed can be long-term agreements and can provide access to full catalogs of books.

The ecosystem of the present invention generates uniform enthusiasm for all parties. Publishers 802 appreciate the revenue model and desire to use it bring their content to the Web while expanding book sales.

Content Processing and Analysis

Editorial system users 102, including, e.g., skilled editors, content analysts and readers, are essential at each phase of the Concept Net creation. These experts are technology-enabled with proprietary tools for content entry and analysis. The editorial expertise 812 includes editorial quality only human expertise can provide is delivered by way of a content preparation process shown in an exemplary embodiment in FIG. 5, that is manageable, scaleable, and cost effective. The content delivery system of the present invention believes this can significantly distinguish its service from other content databases on the Web.

The first stage of content processing includes selecting the best set of books on a given topic such as, e.g., business. Trained readers use a proprietary methodology of FIG. 5 to extract 20-30 critical concepts from each book. Each extract includes one to five paragraphs in the author's verbatim original language. Part-time readers, supported by skilled editors, can be trained to use a networked content entry system 104 so they can work at home or from any other location in the world. A ready pool of highly qualified individuals find it very attractive to be paid a modest wage to read books. Eight hours of reader and editor time can be required to extract a single book. Learning curve effects and ongoing technology improvement can reduce extracting costs over time.

Analysts can review each extract and can identify associated key words and phrases. Using proprietary content analysis software tools, analysts can use the raw database of extracts and keywords to build and expand the classification system 810 of the concept guide 600. This group of concept extracts and key language, can form a semantic network 814 that enables users to describe problems, questions and searches which can then be matched to the concepts that are most appropriate. As new elements are added, the semantic network 814 and the concept guide 600 continuously evolve.

The content delivery system of the present invention in an exemplary embodiment can include a concept guide 600 on a topic including about 400 books containing over 12,000 concepts. Also, 10 to 20 books can be added each month. These can include newly published titles, ongoing select additions from publisher backlists, and bulk additions of books from new publisher partners.

Products

The content delivery system of the present invention can include at least two products in an exemplary embodiment, including Concept Suites and Concept Book Summaries. Concept Suites can include collections of eight or more extracts from multiple books focused on a single business concept. The concept suite is an authoritative, accessible, multi-faceted synopsis of a single business issue that saves valuable time for knowledge worker users 112 while also giving a much broader initial view of each of the hundreds of topic areas. Users 112 can have the ability to identify prepackaged suites related to a topic of interest or to construct custom suites. Concept Suites can be priced, e.g., at $8-$10.

Another category of product is a Concept Book Summary including a sequence of, e.g., 20-30 extracts selected consecutively from a single book, organized by book chapter and cross-referenced by page number in the original book. A summary can be made available for every book on the Concept Net network 170. Concept Book Summaries can be priced at, e.g., $12-$15.

These Concept Suites and Summaries can be searchable via the content delivery system of the present invention concept guide 600—the first comprehensive taxonomy for a given concept. The concept guide 600 can include a three-tiered model including, e.g., nearly 1,000 categories nested under nine primary topics. Each topic in the concept guide 600 can house an interconnected group of extracts or passages quoted verbatim from books. All extracts can be coded and key worded by the content delivery system of the present invention editorial staff, resulting in a powerful semantic network 814. The ideas found in extracts can be accessed by drilling down through the concept guide 600 or by using the concept search tools provided.

The content delivery system of the present invention can also include, e.g., a Personalization System 808—a sophisticated system that can analyze individual usage patterns and adapt user profiles dynamically. It can develop a personal library for each user that contains all the content that has been selected previously by the client user 112, comprehensive activity histories and other individual preference information. The information can be used as the basis for delivering highly tailored individualized recommendations which trigger additional sales.

The content delivery system of the present invention believes that when concept information is available from the desktop, growth of the system can be viral. A similar evolution took place with news delivery over the Internet. The news services started with those individuals who were already active news consumers such as executive management, marketing, sales, and corporate communications. Demand quickly spread to other functions in the organization, and now instant access to news is an imperative for a wide range of business professionals.

Clients can spread the word about the content delivery system of the present invention by forwarding individual extracts and associated preview screens to their colleagues via email. This electronic “brochure” is a publisher-approved activity, and the content delivery system of the present invention can follow up on these prospects with further recommendations and trial offers.

Subscriptions can also provide access to all content in the Concept Net. The content delivery system of the present invention enterprise customers can pay on a per seat basis. Subscriptions can be priced from, e.g., $400-$900 per year for a single user, with volume discounts available for large accounts. These subscriptions can generate additional fees for integration with other information sources utilized by the client.

Subscription pricing for the single user market can be provided in an exemplary embodiment using micro-transaction products.

Other products and services can, include, e.g.,:

A Concept Suite is a collection of eight or more extracts from multiple books focused on a single business concept. It is an authoritative, accessible, multi-faceted synopsis of a single business issue. Users can have the ability to identify prepackaged suites related to a topic of interest or to construct custom suites. Concept Suites, priced at $8-$10, can be the most typical content products purchased through a micro-transaction.

A Concept Book Summary is a sequence of 20-30 extracts selected consecutively from a single book, organized by book chapter and cross-referenced by page number in the original book. A summary is available for every book on the Concept Net. Concept Book Summaries are priced at $12-$15.

Multiple Use License can be provided. The Concept Suites and Concept Book Summaries can be licensed for individual use. Frequently clients desire to deliver content to a number of individuals. Multiple use licenses can be transacted via email and can dramatically streamline the current need to contact each publisher individually. Multiple use licenses can be priced at a volume discount from the individual product prices and can provide valuable exposure of the content delivery system of the present invention to additional prospects.

Concept Courses can offer an in-depth, multiple viewpoint training experience delivered over the Web. Concept Courses can be priced, e.g., between $50-100.

Concept Research Projects can be defined by clients but executed by the content delivery system of the present invention analysts for the client. Expert analysts can perform the most sophisticated searches and make connections that the software may not be capable of. Personalized results can be delivered in a research report built predominantly from concept extracts. Concept Research Projects can be priced from, e.g., $200 and up, depending on the complexity of the problem description.

Enterprise Sales

The content delivery system of the present invention can use a small direct sales team to target organizations with a high concentration of knowledge worker client users 112. Management consulting firms, analysts, and systems integrators are targeted groups. Training and educational organizations are also targets.

The market of consultants, analysts, and systems integrators represents a large prospect pool from which a recurring revenue base can be developed. Explicit or implicit endorsement by these early adopter firms can also be highly valuable to the delivery system's marketing thrust through its syndication partners 806.

Management consultants have a need to stay current with new trends and ideas; often they must become experts on a particular topic overnight. Consultants rely on business books, but they find them only sporadically useful. The difficulty of finding the right material on a timely basis has made books background for consultants, not foreground.

Many management consulting firms maintain their own knowledge databases including past studies, proposals, and other proprietary sources. Ironically, while such databases are conceptually rich, they lack the search tools that identify concepts. The possibility of using the content delivery system of the present invention Concept Net infrastructure 170 and content analysis tools 810 to “concept-enable” these databases is a compelling value proposition to these firms, particularly when cross-referenced or integrated with the book content available in the Concept Net 170.

Several firms also offer electronic information services to their own clients. Many of these firms have a high level of interest in offering the content delivery system of the present invention services to their own clients. The content delivery system of the present invention can agree to provide Concept Net services both internally and to the organization's clients.

Once an agreement has been signed for a group of users in an organization, all employees in the firm can have access to the concept guide 600 browse and search functions. This larger set of users can be encouraged to register and experiment with micro-transaction usage, preferably funded on a metered basis through a corporate account. Firms can charge clients for access to the content delivery system of the present invention. Special features including identifying an account to charge enable charge back to clients.

Syndication Partnering

Broader distribution of the content delivery system of the present invention services can be accomplished using syndication partners 806 with established Web-based services. Partners 806 include, e.g., business news and information services; technology information services; vertical industry services; business service sites; consulting/analysts with online client services; career, training & job search; book resellers; and book and journal publishers 802.

It is desirable to create portals or “vortals” (vertical portals) for aggregating users captured from consumer search engines. The portals drive traffic and are advertising-supported. The business portal's goal is to become a commerce platform such as, e.g., an Amazon.com. The content delivery system of the present invention provides unique, branded content that enables the system to sell concepts to customer users. Furthermore, the personalizing approach of the content delivery system of the present invention creates a one-on-one relationship with premium customers, something very difficult to secure in traffic-focused environments.

The content delivery system of the present invention can work with each partner 806 to create an integrated service offering. The service offerings can be co-branded and integrated within the partner's site, providing a seamless experience for the user. The flexibility of the Concept Net can enable the content delivery system of the present invention to create offerings which specifically appeal to the partner's audience and can map closely to the partner's existing commerce models. For example, the “Information & Technology” portion of the concept guide 600 can be featured at a technology-oriented site, while “Finance & Profits” can be promoted at a financial services site. The content delivery system of the present invention offers full, back-end e-commerce processing for advertising-supported sites which do not register or transact business with their users. Alternatively, the content delivery system of the present invention can piggyback on a partner's registration and commerce system.

The content delivery system of the present invention can also be integrated or placed “inline” with existing functions at a site. Concepts from the Concept Net can be included in the client's search results alongside material resident in the partner's databases. The content delivery system of the present invention can also allow partners 806 to “concept search” other information available on their site. An “e-concept” button can be placed on informational pages to allow a user 112 to view related concepts from the Concept Net 170.

Integration of, e.g., tailored content, customized “in-line” content and service delivery, premium personalization, and commerce capabilities make the content delivery system of the present invention an ideal solution for business and technology partners. The uniqueness of the Concept Net content enables the content delivery system of the present invention to avoid up front real estate charges. Risky guaranteed payments are avoided and the content delivery system of the present invention can access the partner's traffic on a straight revenue-sharing basis.

Some partners 806 can invest in marketing their unique service because of the advantages it provides. For book retailers, the content delivery system of the present invention streamlines the book buying process and can increase actual book sales (e.g., Amazon, Barnes & Noble, ZDNet.) For to picoviented sites seeking to migrate users from consumer portals, unique content is a key differentiator (e.g., for business, Dow Jones and Bloomberg.) Some partners 806 can use the content delivery system of the present invention as an entrée into new markets and as a strategic service for sale to existing customers (e.g., NewsEdge and Disclosure.) The content delivery system of the present invention also can be incorporated as a key feature in new services being launched by the partner 806 (e.g., Dow Jones, Bloomberg and PRNewswire.) The content delivery system of the present invention can enhance these marketing investments through joint campaigns.

Syndication partners 806 can receive, e.g., approximately 30 to 40 percent of the revenue generated for the content delivery system of the present invention at their site. More extensive integration efforts can result in up front payments to the content delivery system of the present invention. In addition to full syndication partners 806, a referral program can be instituted for partners 806 who cross-link and direct traffic to the content delivery system of the present invention home site. These agreements can entail a lower revenue share or simply a cross referral agreement.

The content delivery system of the present invention can engage the services of leading authors, experts and academics to assist in structuring, expansion and direction of the content delivery system of the present invention database. This group can serve as an Advisory Board. Experts in a variety of subjects and industries can work to ensure that the content is optimized and up to date.

Business Model

The content delivery system of the present invention can offer a range of services that encompasses unique free services guiding the user to Concept information obtained through reasonably priced micro-transactions and repeat purchases driven by personalized recommendations.

The content delivery system of the present invention can generate revenue from, e.g., four exemplary sources.

A first source is sale of individual Concept Suites and Book Summaries. The content delivery system of the present invention is seeking large, targeted distribution over the Internet through syndication partners 806 such as online portals (e.g., Dow Jones, Bloomberg) and online booksellers (e.g., Amazon, and Barnes and Noble). Syndication partners 806 can receive, e.g., approximately 30-40% of the content delivery system of the present invention revenue they generate.

A second source is from Corporate Enterprise Licenses. Annual subscription agreements to provide employees of corporations with large numbers of knowledge worker users 112 and major consulting firms (e.g., Bain, Diamond Technology Partners, Gartner Group, and PricewaterhouseCoopers) unlimited access to the content delivery system of the present invention.

A third source is from Actual Book Sales. Publishers 802 view the electronic products first as a new revenue opportunity, and second, as a way to drive incremental traditional book sales as Concept browsing and searching makes it easier to find and preview their print products.

A fourth source is from Advertising Sales. Targeted advertising and sponsorships can be sold on the content delivery system of the present invention and the sites of syndication partners 806.

Long-term, the success of the content delivery system of the present invention results from its ability to scale as a business and to create deep, long-term relationships with its customers to create high average annual sales per customer. The present invention solves the extraction, data entry and content organization issues and provides a scaleable process and system which allows for the cost-effective build out of the Concept database through staffing from readily available talent pools.

The accelerating pace of business has put a premium on innovation and agility. Teams in every functional area are expected to be creative, find new approaches to problems and operate in an environment of constant, rapid change. Work can no longer be carried out according to the old, rigid methodologies. Thus, it is desirable that knowledge worker clients users 112 such as, e.g., business professionals, keep abreast of emerging trends and ideas.

Client users 112 are also depicted in FIG. 8 as knowledge worker users 112. Knowledge workers include large, identifiable categories of professionals who are acutely aware of the need to find and apply new concepts in their work. The following groups of knowledge worker client users 112 actively seek ideas and are well versed in how to apply the ideas, e.g., management consultants, whose essential business is the commerce of ideas; senior corporate managers who must lead and innovate in a rapidly changing world; staff analysts and corporate problem solvers, who formulate and implement new programs and processes; thought leaders and academics, who must be current with new ideas and perspectives; and service professionals, who specialize in, e.g., advertising, public relations, training, and investment.

The content delivery system of the present invention estimates that these groups represent 10 million business professionals in North America. A similarly sized market exists internationally outside North America.

Estimates for Internet users in North America in 1999 range from 80 to 100 million. Within this population, at least 35 to 50 million users can be classified as knowledge worker users 112—professionals whose jobs are dependent on accessing, communicating, and applying a variety of specialized and general information. Beyond this core constituency, an additional market includes 25 million professionals whose jobs increasingly require innovation, conceptual thinking and application of new ideas. All of these knowledge worker users 112 and professionals need easy to use, just-in-time concept information at the desktop.

Value Creation

TABLE II

| Process | Description |
|---|---|
| License Books | About 400 books from various publishers can be |
| | included in a concept database for an exemplary |
| | topic. Approximately 10-20 new books can be |
| | added monthly. |
| Identify Extracts | Readers can identify, extract and index the 20-30 |
| | key concepts in each book. |
| Create Concept Guide | Editors can relate new extracts to thousands of |
| | existing extracts using the semantic network that |
| | drives the Concept Guide. New extracts can be |
| | associated with concept categories in the |
| | proprietary Concept Net, a powerful relational |
| | database. |
| Assemble Concept | The complete extract index for each book can be |
| Book Summaries | organized for preview and purchase as Concept |
| | Book Summary. |
| Build Concept Suites | Eight or more extracts from five or more books, |
| | focused on a single concept, can be organized to |
| | provide diverse perspectives on one topic. |

The content delivery system of the present invention provides concept-based information to the computer desktop. The content delivery system of the present invention' position can deliver content previously unavailable on the Internet combined with breakthroughs in navigation and accessibility.

Locating ideas that can be used to frame a problem can be time consuming, costly and difficult. Outside experts can be hired to bring fresh conceptual approaches to problems. Targeted training, the use of internal “consultants”, and reliance on high visibility “celebrity concepts” (such as re-engineering and total quality management) represent techniques typically used to solve business issues. These approaches demand time and money, so they are employed only for major projects where there is time, budget and sufficient priority.

At the same time, business professionals are becoming increasingly accustomed to desktop information resources which provide aggregated business information that is accessible and inexpensive such as news, financial data, market statistics, company data, and product data. While some of these sources contain a smattering of concept information, it is too sparse and difficult to search to be useful.

As a category, business books, for example, are a rich source of concepts that has been crippled by an extremely ineffective delivery model. The time required to identify the appropriate book and then search its contents for answers is high, so books are a very expensive source of information. Furthermore, one author's point of view is best analyzed in company with the opinions of other authors, making the “single book approach to problem solving” incomplete.

There are print-based business book “executive summary” services that modestly reduce the cost of accessing book content. These digested services offer no search capability, do not focus on solving a particular problem, and summarize at such a general level that limits their usefulness in most business contexts. Despite these drawbacks, these services command a subscription base of users that are prime prospects for the content delivery system of the present invention.

No single publisher could provide the aggregation function offered by the content delivery system of the present invention. As a result of its publisher alliances, the content delivery system of the present invention can introduce a service with truly unique, branded content. By building alliances with the major business Internet players in this market space, the content delivery system of the present invention can secure the key Web real estate and create significant competitive barriers.

Creating syndication agreements with a range of web information services solidifies the content delivery system of the present invention position even further. Each partner 806 can have a fully developed the content delivery system of the present invention service that can be uniquely integrated with its existing site. Through this strategy, the content delivery system of the present invention can collaborate rather than compete with business information providers on the web, while establishing itself as the standard for desktop access to concepts.

The content delivery system of the present invention can also create customer alliances with, e.g., knowledge-intensive organizations including consulting and analyst firms, training organizations, systems integrators and educational institutions. These groups can be targeted as early adopters of the service. Some of these organizations can also offer electronic services to their own clients, and the content delivery system of the present invention can structure specialized syndication arrangements for these companies.

Because the content owners (i.e., book publishers 802) have not migrated to electronic content and do not have resources to do so, it is unlikely they can follow the content delivery system of the present invention into the market. By turning potential competitors—from, e.g., online information companies to consulting firms—into partners 806, the content delivery system of the present invention can reduce likely competitors and raise barriers to other entrants.

Viral Marketing

Business books contain a vast store of content that is high quality, authoritative, branded and unique. It has been trapped in a delivery model that has not changed for a hundred years. This business resource is underutilized given the market potential.

When concept information is available from the desktop, its growth can be viral. A similar evolution took place with news delivery over the Internet. The news services started with those individuals who were already active news consumers such, e.g., as executive management, marketing, sales, corporate communications. The demand quickly spread to other functions in the organization, and now instant access to news is an imperative for a wide range of business professionals.

Instant access to concept information has a similar imperative. Most knowledge worker users 112 are aware that valuable content buried in business books could impact significantly the quality of their decisions. Books have been a secondary resource for business problem solving because of the high overhead in personal time required to first identify the most appropriate title and then find the key passages. Once these access impediments are removed, demand for high quality concept information can spread throughout the organization. The content delivery system of the present invention accelerates this growth through syndicating concepts at hundreds of web sites along with innovative marketing approaches.

The pent up demand for concept-focused knowledge is already substantial and it is growing. In addition to just-in-time business concepts, other related knowledge domains (such as technology, career development and investments) can be added. This long-term opportunity is the big vision that drives the content delivery system of the present invention.

Personalization and Customization

One of the most significant advantages provided by the content delivery system of the present invention is personalization. The Concept Net 170 identifies and delivers conceptual content precisely targeted to a user's interests on an ongoing basis. Personalization systems 808 enable users to maintain and modify a personal profile. These systems also analyze individual usage patterns and adapt user profiles dynamically. A personal library can be maintained for each user that contains all the content that has been selected previously. A unique library for each user, comprehensive activity histories and other individual preference information can provide the basis for delivering highly tailored individualized services.

Working with business information partners on the web, the content delivery system of the present invention can also extend the Concept Net 170 to locate and include related conceptual information resident in other databases. This capability can expand the power of the Concept Net 170 and can enable unique service offerings to be created with syndication partners 806.

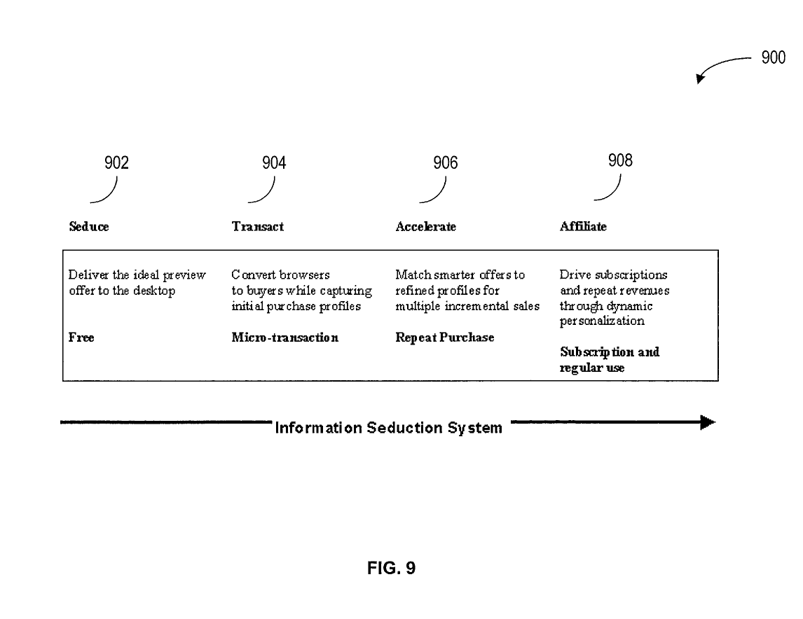

FIG. 9 illustratively depicts an exemplary embodiment of an information seduction system 900 of the present invention. The information seduction system 900, advantageously features a seducing step 902, a transacting step 904, an accelerating step 906, and an affiliating step 908.

A dichotomy exists today in revenue models for information providers on the Web. The rapid expansion of advertising-supported sites has given rise to an abundance of free information services. Successful user-paid information services are clustered around subscriptions for focused business data. Internet users are predisposed to the notion that information should be free and are often reluctant to even investigate services that carry a price tag.

The content delivery system of the present invention can offer a range of services that encompasses free offerings, information obtained through reasonably priced micro-transactions and repeat purchases driven by personalized recommendations. The present invention creates models that migrate users from useful, unique “preview” information to paid content and services. Users can conduct extensive research on their specific problems and then preview the results before they buy. “Preview before buying” can be used to sell expensive multi-client research services. The content delivery system of the present invention offers user-driven, concept research from leading authorities at price points that encourage spontaneous purchase.

All web users can have free access to the content delivery system of the present invention concept guide 600 and Concept Search capabilities. Users accustomed to the world of free information can become acquainted with powerful tools for structuring concept-focused inquiries and for obtaining highly targeted book recommendations. Using the Concept Net at the free access level, users can preview screens which provide the name, author, book reference and concept names and “call outs” like those used to pull readers into magazine articles. While these preview screens contain useful information, they can also be designed to intrigue users and encourage them to buy what is “behind the curtain” through micro-transactions.

From the first encounter with the content delivery system of the present invention, a user can be invited to register and create a profile. New users can receive individualized recommendations immediately based on the initial search activity. This can result from user-supplied data or by creating a user profile dynamically from usage patterns. A “Recommendation Center” can present a weekly summary of new concepts pertinent to the interests of an individual client. Every user interaction can increase the accuracy of the recommendations provided.

Revenues for the content delivery system of the present invention can be driven by an information seduction system built around several exemplary elements including, e.g., access to a unique and intriguing set of free capabilities; use of personalized promotions offering fee-based content; ability to obtain unique content economically, which leads to additional content previews and links; and continual refinement of promotions and services, by learning from each individual's usage patterns and preferences.

Every registered client user 112 can be actively encouraged to continue their usage and to share the content delivery system of the present invention with colleagues. Satisfied clients can spread the word about the content delivery system of the present invention by forwarding individual extracts and associated preview screens to their colleagues via email. This electronic “brochure” can be a publisher-approved activity, and the content delivery system of the present invention can follow up on these prospects with further recommendations and trial offers.

Exemplary Implementation Environment

An exemplary content delivery system according to the present invention is available from MeansBusiness.com, of Boston, Mass., U.S.A. Meansbusiness.com is an e-commerce and knowledge management company that provides mass-customized publishing and electronic distribution services for works of authorship including, e.g., non-fiction books, periodicals, and research reports. The content delivery system according to the present invention can select extracts, preferably key, verbatim extracts, (referred to as “concepts”) from the works of authorship; can repackage the extracts into compilations (referred to as “concept suites” and “concept book summaries”); can provide a sophisticated directory, search engine and personalization system 808 for navigating a concept database; and can organize syndication, sale and delivery of the concept suites and concept book summaries over a distribution media, such as, e.g., the global Internet.

The content delivery system according to the present invention can use the Internet to unlock content from the centuries-old paper-based distribution paradigm. The net effect of this new publishing and distribution system is broader, faster, cheaper dissemination of knowledge information to businesses and consumers. Knowledge worker client users 112 can now acquire more information because of the shortened time and cost commitment, while publishers 802, described further above with reference to FIG. 8, can increase their content ROI through sales of new electronic products while at the same time driving increased demand for their original print products.

The content delivery system of the present invention has been illustratively described with reference to a product set including “Business” books targeted broadly at the 20-25 million knowledge worker users 112. In addition to just-in-time business concepts, the content delivery system of the present invention model can be quickly applied to other knowledge domains such as, e.g., Technology, Career Development, Investments, and Personal Development as well as non-business fields such as Health, Law, Science, and Engineering. The opportunity to redefine how ideas are shared and used in all these market spaces is the big vision that drives the content delivery system of the present invention.

The content delivery system of the present invention can enter into partnerships with publishers 802 which can allow seasoned editors of the content delivery system of the present invention to extract, e.g., concise, verbatim summaries of key concepts from thousands of books for professionals and deliver them directly to the desktop.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for extracting, organizing, and providing access to conceptual information, comprising:
a) editing and aggregating conceptual content information comprising at least one of:
1) isolating conceptual content information from raw textual content information,
2) aggregating related conceptual content information,
3) organizing said conceptual content information,
4) structuring said conceptual content information,
5) retaining verbatim original language of said plurality of authors,
6) adding links and keywords,
7) extracting conceptual content information from a plurality of authors,
8) establishing a conceptual overview of raw textual content data,
9) tagging positive locations in said raw textual content data of conceptual content information passages,
10) performing a negative pass to remove time consuming content,
11) identifying and isolating said conceptual content information passages,
12) extracting said conceptual content information passages and identifying said conceptual content information passages by a top level concept and an information object term,
13) proofreading and editing said conceptual content information passages,
14) performing a final edit of said conceptual content information passages,
15) adding graphic images to said conceptual content information, and
16) linking said conceptual content information to a plurality of information object terms;
b) organizing said conceptual content information from said plurality of authors including information relating to professional fields including at least one of work, business, and research, in an adaptable extensible framework supporting a plurality of information object terms,
wherein said information object terms can be selected from a group comprising at least one of a type, a concept, a keyword, a suite, a table of contents (TOC), a publisher, an author function, an author, a section, an extract, a component, and a title, and
wherein any first information object term of said plurality of information object terms is related to a second information object term of said plurality of information object terms as identified in a term table database and a linkage table database;
c) optimizing said conceptual content information for user access at a computing device into optimized conceptual content information comprising:
1) reading a record of said conceptual content information,
2) determining whether said record is a main object and if so then creating javascript variable (VAR) file for a main object and content is placed in said javascript VAR file,
3) preassociating said conceptual content information, including following parent/child links and accessing any associated objects,
4) adding javascript VAR code for said any associated objects,
5) storing javascript VARs in an optimized database, and
6) writing javascript file to javascript to include directory of web server; and
d) delivering said optimized conceptual content information to a user at said computing device, comprising:
1) receiving a request for a content page of said optimized conceptual content information from a browser,
2) reading javascript include file including javascript VAR statements from said optimized database,
3) transmitting said javascript to said browser,
4) transmitting a javascript function rendering library to said browser, and
5) transmitting a page layout and formatting to said browser for rendering said content page at said browser.

2. A method for extracting, organizing, and providing access to conceptual information, comprising:
a) editing and aggregating conceptual content information;
b) organizing said conceptual content information from said plurality of authors in an adaptable extensible framework supporting a plurality of information object terms;
c) optimizing said conceptual content information for user access at a computing device into optimized conceptual content information; and
d) delivering said optimized conceptual content information to a user at said computing device.

3. The method according to claim 2, wherein said step (a) comprises at least one of:
1) isolating conceptual content information from raw textual content information;
2) aggregating related conceptual content information;
3) organizing said conceptual content information;
4) structuring said conceptual content information;
5) retaining verbatim original language of said plurality of authors; and
6) adding links and keywords.

4. The method according to claim 2, wherein said step (a) comprises at least one of:
1) extracting conceptual content information from a plurality of authors;
2) establishing a conceptual overview of raw textual content data;
3) tagging positive locations in said raw textual content data of conceptual content information passages;
4) performing a negative pass to remove time consuming content;
5) identifying and isolating said conceptual content information passages;
6) extracting said conceptual content information passages and identifying said conceptual content information passages by a top level concept and an information object term;
7) proofreading and editing said conceptual content information passages;
8) performing a final edit of said conceptual content information passages;
9) adding graphic images to said conceptual content information; and
10) linking said conceptual content information to a plurality of information object terms.

5. The method according to claim 2, wherein said step (b) comprises:
1) organizing said conceptual content information wherein said conceptual content information relates to professional fields including at least one of work, business, and research.

6. The method according to claim 2, wherein said information object terms can be selected from a group comprising at least one of a type, a concept, a keyword, a suite, a table of contents (TOC), a publisher, an author function, an author, a section, an extract, a component, and a title.

7. The method according to claim 2, wherein any first information object term of said plurality of information object terms is related to a second information object term of said plurality of information object terms as identified in a term table database and a linkage table database.

8. The method according to claim 2, wherein said step (c) comprises at least one of:
1) reading a record of said conceptual content information;
2) determining whether said record is a main object and if so then creating javascript variable (VAR) file for a main object and content is placed in said javascript VAR file;
3) preassociating said conceptual content information, including following parent/child links and accessing any associated objects;
4) adding javascript VAR code for said any associated objects;
5) storing javascript VARs in an optimized database; and
6) writing javascript file to javascript to include directory of web server.

9. The method according to claim 2, wherein said step (d) comprises at least one of:
1) receiving a request for a content page of said optimized conceptual content information from a browser;
2) reading javascript include file including javascript VAR statements from said optimized database;
3) transmitting said javascript to said browser;
4) transmitting a javascript function rendering library to said browser; and
5) transmitting a page layout and formatting to said browser for rendering said content page at said browser.

10. A system for extracting, organizing, and providing access to conceptual information, comprising:
means for editing and aggregating conceptual content information comprising at least one of:
means for isolating conceptual content information from raw textual content information,
means for aggregating related conceptual content information,
means for organizing said conceptual content information,
means for structuring said conceptual content information,
means for retaining verbatim original language of said plurality of authors,
means for adding links and keywords,
means for extracting conceptual content information from a plurality of authors,
means for establishing a conceptual overview of raw textual content data,
means for tagging positive locations in said raw textual content data of conceptual content information passages,
means for performing a negative pass to remove time consuming content,
means for identifying and isolating said conceptual content information passages,
means for extracting said conceptual content information passages and identifying said conceptual content information passages by a top level concept and an information object term,
means for proofreading and editing said conceptual content information passages,
means for performing a final edit of said conceptual content information passages,
means for adding graphic images to said conceptual content information, and
means for linking said conceptual content information to a plurality of information object terms;
means for organizing said conceptual content information from said plurality of authors including information relating to professional fields including at least one of work, business, and research, in an adaptable extensible framework supporting a plurality of information object terms,
wherein said information object terms can be selected from a group comprising at least one of a type, a concept, a keyword, a suite, a table of contents (TOC), a publisher, an author function, an author, a section, an extract, a component, and a title, and
wherein any first information object term of said plurality of information object terms is related to a second information object term of said plurality of information object terms as identified in a term table database and a linkage table database;
means for optimizing said conceptual content information for user access at a computing device into optimized conceptual content information comprising:
means for reading a record of said conceptual content information,
means for determining whether said record is a main object and if so then creating javascript variable (VAR) file for a main object and content is placed in said javascript VAR file,
means for preassociating said conceptual content information, including following parent/child links and accessing any associated objects,
means for adding javascript VAR code for said any associated objects,
means for storing javascript VARs in an optimized database, and
means for writing javascript file to javascript to include directory of web server; and
means for delivering said optimized conceptual content information to a user at said computing device, comprising:
means for receiving a request for a content page of said optimized conceptual content information from a browser,
means for reading javascript include file including javascript VAR statements from said optimized database,
means for transmitting said javascript to said browser,
means for transmitting a javascript function rendering library to said browser, and
means for transmitting a page layout and formatting to said browser for rendering said content page at said browser.

11. A system operative to extract, organize, and provide access to conceptual information, comprising:
an editorial system operative to edit and aggregate conceptual content information;
an editorial database operative to organize said conceptual content information from said plurality of authors in an adaptable extensible framework supporting a plurality of information object terms;
an optimize database operative to optimize said conceptual content information for user access at a computing device into optimized conceptual content information; and
a content delivery system operative to deliver said optimized conceptual content information to a user at said computing device.

12. The system according to claim 11, wherein said editorial system comprises at least one of:
an isolator operative to isolate conceptual content information from raw textual content information;
an aggregator operative to aggregate related conceptual content information;
an organizer operative to organize said conceptual content information;
a structure operative to structure said conceptual content information;
a database operative to retain verbatim original language of said plurality of authors; and
a database operative to add links and keywords.

13. The system according to claim 11, wherein said editorial system comprises at least one of:
an editor operative to at least one of extract conceptual content information from a plurality of authors, establish a conceptual overview of raw textual content data, tag positive locations in said raw textual content data of conceptual content information passages, perform a negative pass to remove time consuming content, identify and isolate said conceptual content information passages, extract said conceptual content information passages and identify said conceptual content information passages by a top level concept and an information object term, proofread and edit said conceptual content information passages, and perform a final edit of said conceptual content information passages;
a graphics module operative to add graphic images to said conceptual content information; and
a link process operative to link said conceptual content information to a plurality of information object terms.

14. The system according to claim 11, wherein said conceptual content information relates to professional fields including at least one of work, business, and research.

15. The system according to claim 11, wherein said information object terms comprise at least one of a type, a concept, a keyword, a suite, a table of contents (TOC), a publisher, an author function, an author, a section, an extract, a component, and a title.

16. The system according to claim 11, wherein any first information object term of said plurality of information object terms is related to a second information object term of said plurality of information object terms as identified in a term table database and a linkage table database.

17. The system according to claim 11, wherein said optimize database comprises:
an optimization process operative to at least one of read a record of said conceptual content information, determine whether said record is a main object and if so then creating javascript variable (VAR) file for a main object and content is placed in said javascript VAR file, preassociate said conceptual content information, including following parent/child links and accessing any associated objects, add javascript VAR code for said any associated objects, store javascript VARs in an optimized database, and write javascript file to javascript to include directory of web server.

18. The system according to claim 11, wherein said content delivery system is operative to at least one of receive a request for a content page of said optimized conceptual content information from a browser, read javascript include file including javascript VAR statements from said optimized database, transmit said javascript to said browser, transmit a javascript function rendering library to said browser, and transmit a page layout and format to said browser for rendering said content page at said browser.

19. A graphical user interface for user access to three or more levels of organizational hierarchy of content topics comprising:
a pie-shaped interface comprising a plurality of pie slices wherein each pie slice of said pie-shaped interface represents a high level topic for user interaction;
wherein upon user-selection of any of said plurality of pie slices, a plurality of medium level topics are displayed for user interaction, and
wherein, in turn, upon user-selection of any of said plurality of medium level topics, a plurality of low level topics are displayed for user interaction.
